(19) United States
(12) Patent Application Publication
(10) Pub. No.: US 2006/0028621 A1
(43) Pub. Date: Feb. 9, 2006

(54) Integral reflector and heat sink

(76) Inventors: Anurag Gupta, Corvallis, OR (US); David L. Erickson, Philomath, OR (US); Kuohua Wu, Tucson, AZ (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/242,718

(22) Filed: Oct. 5, 2005

Related U.S. Application Data
(63) Continuation-in-part of application No. 10/769,355, filed on Jan. 30, 2004.

(51) Int. Cl. G03B 21/16

(52) U.S. Cl. 353/52

(57) ABSTRACT

An integral reflector and heat sink for use in a projector assembly is provided herein. The integral reflector and heat sink according to one exemplary embodiment includes a reflector portion having an integrated heat sink with a reflective surface and a non-reflective surface opposite the reflective surface. An emissivity treatment is applied to the non-reflective surface. The emissivity treatment is configured to increase a heat transfer rate through said non-reflective surface.

### RELATED APPLICATION

This application is a CIP of U.S. application Ser. No. 10/769,355 filed Jan. 30, 2004, which application is hereby incorporated by reference herein.

### BACKGROUND

Digital projectors, such as digital mirror devices (DMD) and liquid crystal display (LCD) projectors, project high-quality images onto a viewing surface. Both DMD and LCD projectors utilize high-intensity lamps and reflectors to generate the light needed for projection. Light generated by the lamp is concentrated as a “fireball” that is located at a focal point of a reflector. Light produced by the fireball is directed into a projection assembly that produces images and utilizes the generated light to form the image. The image is then projected onto a viewing surface.

Efforts have been directed at making projectors more compact while making the image of higher and better quality. As a result, the lamps utilized have become more compact and of higher intensity. An example of one type of such lamp is known as a xenon lamp. Xenon lamps provide a relatively constant spectral output with significantly more output than other types of lamps without using substantial amounts of environmentally harmful materials, such as mercury. In addition, xenon lamps have the ability to hot strike and subsequently turn on at near full power.

Higher intensity lamps produce high, even extreme heat. If this heat is allowed to accumulate in the lamp, it may shorten the useful life of the lamp. For example, a xenon lamp operating on 330 watts (W) of input power often produces about 69 W of visible light. The remaining power generates infrared radiation, black body radiation, and ultraviolet radiation or is consumed by electrical losses. As a result, the light generation assembly needs to dissipate about 250 W of power. Some designs attempt to dissipate the energy by reflecting the radiation away from the lamp and removing the heat with separate heat sinks.

### SUMMARY

An integral reflector and heat sink for use in a projector assembly is provided herein. The integral reflector and heat sink according to one exemplary embodiment includes a reflector portion having an integrated heat sink with a reflective surface and a non-reflective surface opposite the reflective surface. An emissivity treatment is applied to the non-reflective surface. The emissivity treatment is configured to increase a heat transfer rate through said non-reflective surface.

### BRIEF DESCRIPTION OF THE DRAWINGS

The accompanying drawings illustrate various embodiments of the present apparatus and method and are a part of the specification. The illustrated embodiments are merely examples of the present apparatus and method and do not limit the scope of the disclosure.

FIG. 1 is a schematic view of a display system.

FIG. 2 illustrates a perspective view of an integrated assembly according to one exemplary embodiment.

FIG. 3 is a flowchart illustrating a method of forming a lamp assembly according to one exemplary embodiment.

FIG. 4 is a schematic view of a display system and lamp assembly according to one exemplary embodiment.

FIG. 5 is a schematic view of a display system and lamp assembly according to one exemplary embodiment

Throughout the drawings, identical reference numbers designate similar, but not necessarily identical, elements.

### DETAILED DESCRIPTION

The present apparatuses and methods are related to an integral reflector and heat sink for use in lamp assemblies used in display systems. According to one exemplary embodiment, a reflector is provided that is configured to act as a reflector while providing for enhanced cooling of a lamp assembly. Such a reflector may be referred to as an integrated unit. The integrated unit includes an emissivity-controlling treatment applied to a non-reflective surface thereof to control the emissivity of that surface. Emissivity refers to the relative power of a surface to emit heat by radiation. The emissivity-control treatment may increase the effectiveness of the display system in cooling the lamp. Increasing the effectiveness in cooling the lamp may increase the efficiency of the display system.

In the following description, for purposes of explanation, numerous specific details are set forth in order to provide a thorough understanding of the present method and apparatus. It will be apparent, however, to one skilled in the art that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Display System

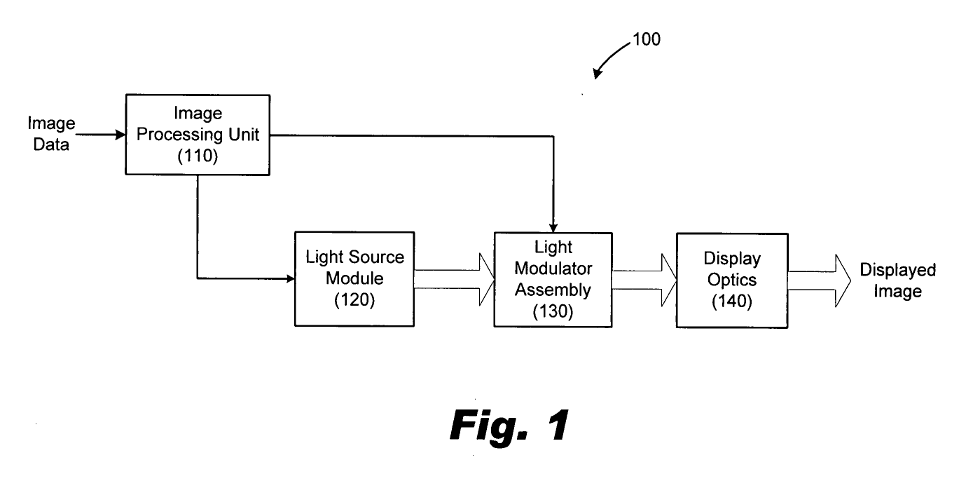

FIG. 1 illustrates an exemplary display system (100). The components of FIG. 1 are exemplary only and may be modified or changed as best serves a particular application. As shown in FIG. 1, image data is input into an image processing unit (110). The image data defines an image that is to be displayed by the display system (100). While one image is illustrated and described as being processed by the image processing unit (110), it will be understood by one skilled in the art that a plurality or series of images may be processed by the image processing unit (110). The image processing unit (110) performs various functions including controlling the illumination of a light source module (120) and controlling a light modulator assembly (130).

As will be discussed in more detail below, according to one exemplary embodiment, the light source module (120) includes a lamp assembly, which includes an anode and a cathode coupled to a reflector. According to another exemplary embodiment, the lamp assembly includes a burner coupled to a reflector. In any case, the reflector includes a burner surface, and a non-burner surface. The burner surface is reflective, such that a portion of light generated by the light source module (120) that is incident on the burner surface is reflected out of the light source module (120).

In addition to generating light in the visible spectrum, the light source module (120) also generates other forms of radiation. The metallic reflector absorbs a substantial portion of this radiation from the reflective side of the reflector and transmits the radiation to the non-reflective side via conduction. This radiation exits the non-reflective side of the reflector in more than one form, such as in the form of radiant energy and energy transported away by convection. How much of the radiation that is transferred by convection and how much is transmitted as radiant energy depends, at least in part, on the emissivity of the surfaces on the non-reflective side of the reflector. As will be discussed in more detail, the emissivity of the non-reflective side surfaces may be controlled or selected to thereby control how the radiation is dissipated to suit the configuration of the display system (100).

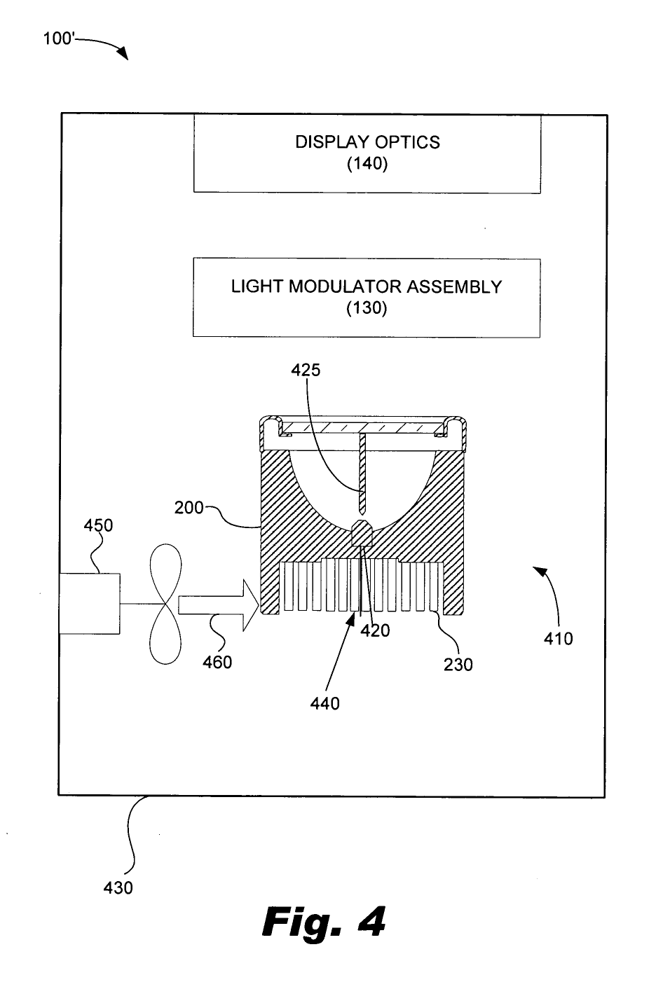

For example, according to on exemplary embodiment, the components of the display system are located within a housing. It may be desirable to vary the emissivity of the non-reflective side surfaces based on the location of the light source module (120), and of the non-burner side of the reflector in particular. For example, the light source module (120) may be located at a relatively distant location from the housing, as will be discussed in more detail with reference to FIG. 4. According to such an exemplary embodiment, the radiated energy may not be radiated outside the housing directly or easily. Thus, it may be desirable to dissipate the radiation from the non-reflective side surfaces by convection. As will be discussed in more detail below, the non-reflective side surfaces may be treated to lower the emissivity thereof such that the non-reflective surfaces are heated relatively rapidly.

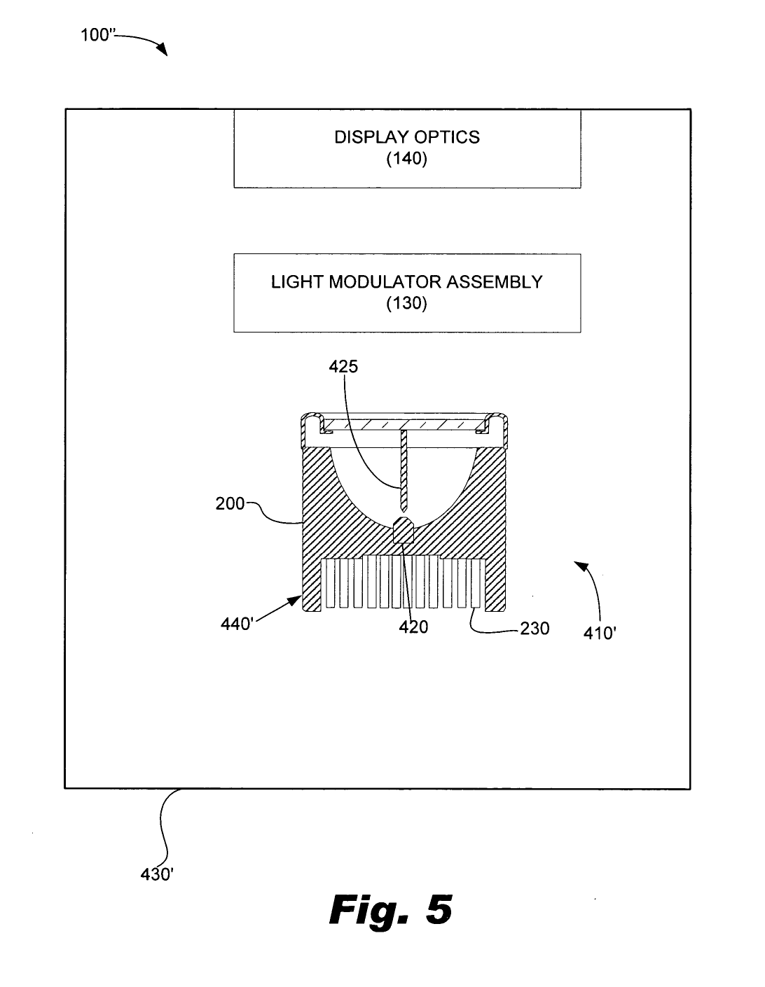

Similarly, according to another exemplary embodiment, the light source module (120) may be located at a location where the radiation may be readily dissipated as radiant energy, as will be discussed in more detail with reference to FIG. 5. In such a case it may be desirable to maximize the emissivity of the non-reflective side of the reflector to maximize radiation and reduce convection. According to one exemplary embodiment discussed below, the reflector is metallic with fins on the non-reflective side. The fins provide a large surface area to radiate heat. Thus the amount of radiant energy that can be dissipated may be increased by increasing the surface area of the non-burner side.

The light source module (120) is positioned with respect to the light modulator assembly (130). The incident light may be modulated in its color, phase, intensity, polarization, or direction by the light modulator assembly (130). Thus, the light modulator assembly (130) of FIG. 1 modulates the light based on input from the image processing unit (110) to form an image-bearing beam of light that is eventually displayed or cast by display optics (140) on a viewing surface (not shown).

The display optics (140) may include any device configured to display or project an image. For example, the display optics (140) may be, but are not limited to, a lens configured to project and focus an image onto a viewing surface. The viewing surface may be, but is not limited to, a screen, television, wall, liquid crystal display (LCD), or computer monitor.

Integrated Unit

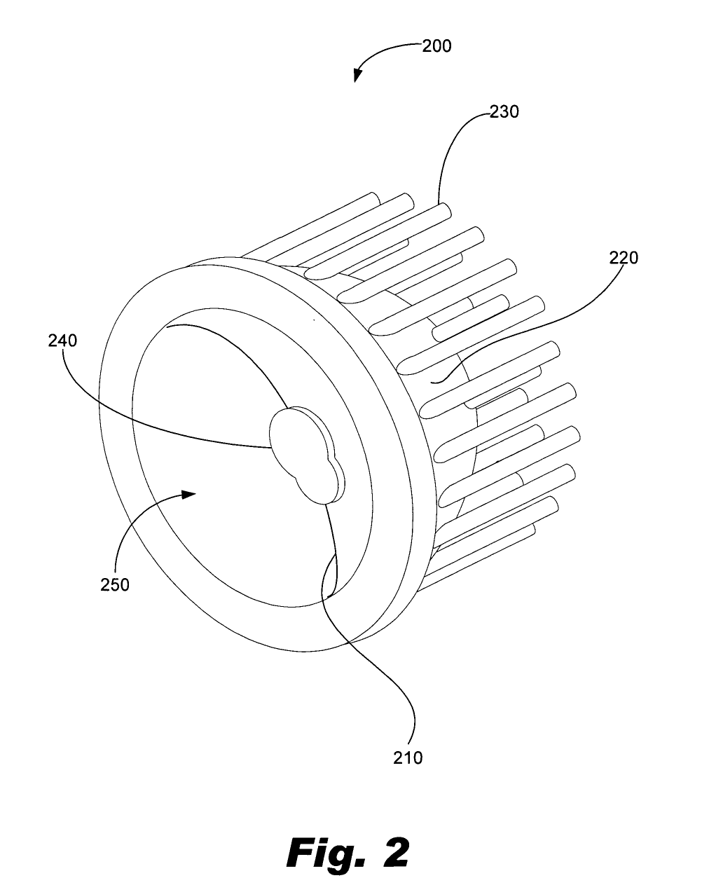

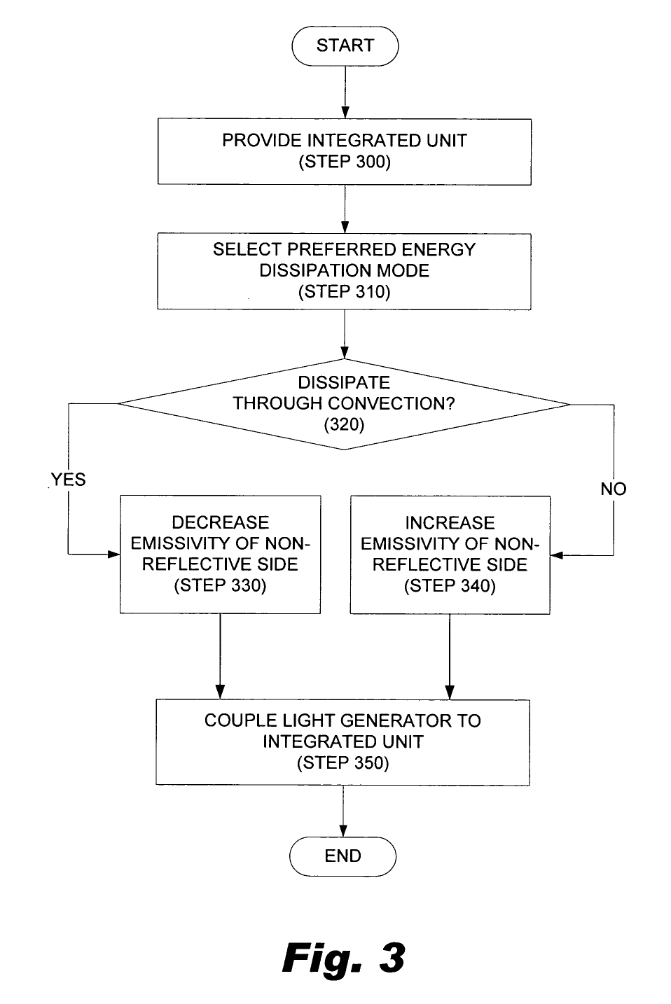

FIG. 2 illustrates an integral reflector and heat sink, referred to herein as the “integrated unit” (200). The integrated unit (200) is configured to be part of a lamp assembly, as will be discussed in more detail with reference to FIG. 3. The integrated unit (200) includes a reflective surface (210), a reflector body (220), a plurality of integral cooling fins (230) and a reflector opening (240). The integrated unit (200) reflects visible light out and dissipates energy through the reflector body (220) and the cooling fins (230).

The reflective surface (210) is formed in a cavity (250) defined in a distal end of the reflector body (220) on the reflective side of the integrated unit (200). The cavity (250) may be spherical or aspherical in profile. According to one exemplary embodiment, the profile is generally elliptical. As a result, a substantial portion of light originating from a focal point of the cavity (250) reflects off the reflective surface (210) and out of the integrated unit (200). The reflector opening (240) according to the present exemplary embodiment allows an anode to be coupled to the integrated unit (200). A cathode may then also be coupled to the integrated unit (200) at a position that establishes a gap between the cathode and the anode. According to other exemplary embodiments, the reflector opening (240) may be sized to allow at least a portion of a burner to be passed therethrough. In either case, the integrated unit (200) is configured to be part of a lamp assembly that generates light from or near the focal point of the elliptical profile.

Light in the visible spectrum is the desired output of a lamp used in projector systems. However, as previously discussed, lamps also generate significant radiation outside the visible spectrum. The reflective surface (210) may include a radiation absorption layer on the reflective side, such as an infrared and/or ultraviolet radiation absorption material. Such a coating may increase the amount of energy outside the visible spectrum that is absorbed by the integrated unit (200). Other coatings may be also be applied to the reflective surface (210), including reflective coatings. The performance of many coatings may degrade over time if subjected to elevated temperatures. Thus, it may be desirable to maintain the reflective surface (210) below a predetermined temperature threshold.

The emissivity of the non-reflective side of the integrated unit (200) is treated to draw sufficient energy away from the reflective surface (210) to maintain the reflective surface below the predetermined temperature threshold. For example, the non-reflective side may be treated to increase the heat dissipated through convection or to increase the heat dissipated through radiation. In either case, the emissivity treatment increases the heat transfer rate of the non-reflective side of the integrated unit (100). This increase in the rate of heat transfer from the non-reflective side draws heat from the reflective surface (210). This heat is transmitted to the non-reflective side through conduction. The relative amount of energy dissipated through radiation or convection depends, at least in part, on the emissivity of the non-reflective side surfaces. By controlling the emissivity of these surfaces, the temperature of the reflective surface (210) may be maintained below a predetermined temperature threshold, as will be discussed in more detail below.

Method of Cooling a Lamp Assembly

FIG. 3 is a flowchart illustrating a method of cooling a lamp assembly according to one exemplary embodiment. While certain steps are described herein, those of skill in the art will appreciate that the steps may be performed in different order and/or steps may be omitted. The method begins by providing an integral reflector and heat sink (integrated unit) (step 300). According to one exemplary embodiment, the integrated unit is formed of a metallic material. For example, the integrated unit may be machined from a block of metal to establish a cavity therein and form a reflective surface. The reflective surface may be referred to as being on the burner side of the reflector. The non-reflective side of the integrated unit therefore corresponds to the surface opposite the reflective surface. Forming the integrated unit may also include forming a plurality of cooling fins on the non-burner side of the integrated unit. Providing the integrated unit (step 300) may also include depositing one or more coatings, such as reflective and/or IR absorbing coatings on the reflective surface.

Thereafter, the preferred energy dissipation mode is selected (step 310). As previously discussed, in addition to generating visible light, operation of a lamp assembly also produces other forms of energy, including radiant energy and thermal energy. Selecting the desired heat transfer mode (step 310) according to the present exemplary embodiment includes determining whether to dissipate an increased amount of the radiation as radiant energy or by convection (determination 320).

The heat can be carried away from the reflector by any of the three modes: conduction, convection or radiation. If conduction as a heat transfer mechanism is minimal and thus ignored, then radiation and convection dominate. In such a case, the energy balance equation is given by:
Eₙₑₜ=convection+radiation
If radiation is reduced then the convection may be increased and vice versa according to the energy balance equation.

The energy dissipated from an object through radiation may be calculated using the equation:
E=Aπ∫₀^{∞}L_{λ}ε(λ)dλ−σATₐ⁴
where E is the energy radiated away, A is the surface area, ε(λ,Ts) is the emissivity of the reflector material, λ is the wavelength of the radiation, and σ is the Stephan-Boltzman constant. The radiance of the blackbody, L_{λ}, may be further calculated by the equation:

$${L}_{γ} = \frac{2 {hc}^{2}}{{λ}^{5} ( {ⅇ}^{\frac{hc}{λ k {T}_{s}}} - 1 )}$$

where h is Planck's constant, c is the speed of light, k is the Boltzmann constant, Tₛ is the surface temperature of the non-reflective side surface, and Tₐ is the ambient temperature. If ε(λ, Tₛ) is independent of the wavelength of the radiation to be dissipated and the temperature of the radiating surface, then energy radiated away may be estimated by the equation:
E=εσA(Tₛ⁴−Tₐ⁴)
Thus, the amount of radiation dissipated or radiated away from the integrated unit in the form of radiant energy depends, at least in part, on the emissivity of the surfaces on the non-reflective side.

Consequently, increasing the emissivity of those surfaces provides for an increase in the radiant heat radiated away from the integrated unit. Similarly, reducing the emissivity of the surface on the non-reflective side of the integrated unit causes the energy absorbed by the integrated unit to heat up the non-reflective side surfaces. As the non-reflective side surface is heated, the heat may be dissipated through convective cooling. The heat transfer rate from the non-reflective side surfaces may calculated by the equation:
Convection=hAΔT
where h is an empirically calculated number that is a function of geometry and airflow, A is the surface area taking part in convection, and ΔT is the difference in temperature between the surface and the ambient temperature. Thus, for a given airflow over a surface with a fixed area, dissipation of energy through convective cooling may be increased by increasing the temperature of the surface. This increase in the convective cooling rate may be achieved, at least in part, by decreasing the emissivity of the non-reflective side surfaces. Thus, convective cooling may be increased by decreasing emissivity while radiant cooling may be increased by increasing emissivity.

Rewriting the energy balance equation with radiation and convection formulas gives

E_{NET}=hA(Tₛ−Tₐ)+σεA(Tₛ⁴−Tₐ⁴)

As the emissivity, ε, is varied the surface temperature Tₛ varies dramatically. If ε is increased, heat transfer by radiation increases and Tₛ falls rapidly. However if ε is reduced, Tₛ increases rapidly, thereby increasing heat transfer by convection. As previously introduced, reflective coatings may not be stable above a certain temperature. Thus, it may be desirable to operate the lamp such that the surface temperature does not exceed a certain level. Under such circumstances, the emissivity on the back side of the reflector can be increased to lower surface temperature resulting in reduced convection and increased radiation.

Accordingly, if it is desirable to increase the dissipation of the energy absorbed by the integrated unit by convection (YES, determination 320), the non-reflective side surface is treated to decrease emissivity (step 330). If the energy absorbed by the integrated unit is to be dissipated as radiant energy (NO, determination 320), the non-reflective side surface is treated to increase emissivity (step 340). Several exemplary treatments will be discussed in more detail below. The emissivity of a surface of a metallic material, such as the surface of an aluminum object, can be changed by adding coatings, anodization, and/or various surface treatments such as etching or sandblasting. Such treatments will be discussed in more detail below.

Once the integrated unit has been formed and the emissivity of the non-reflective side surface has been selected and treated, a light generator is coupled to the integrated unit (step 350). For example, according to one exemplary embodiment, coupling a light generator to the integrated unit may include sealingly coupling an anode and a cathode to the integrated unit with a gap therebetween and filling the integrated unit with a pressurized gas, such as Xenon. According to another exemplary embodiment, coupling a light generator to the integrated unit may include coupling a burner, such as an ultra-high pressure mercury burner, to the integrated unit. In any case, a light generator is configured to produce light in response to the application of power. The control of the emissivity of the non-reflective side surface provides for the selection of the heat dissipation mode. One exemplary integrated unit will now be introduced, followed by a discussion of projection assemblies and the location of lamp assemblies within the projection assemblies.

Lamp Assemblies

FIG. 4 illustrates a partial schematic view of a display system (100′) that focuses on a lamp assembly (410) according to one exemplary embodiment. The display system includes a lamp assembly (410) that includes an integrated unit (200) and having an anode (420) and cathode (425) coupled thereto. The anode (420) and cathode (425) have a gap established therebetween. The integrated unit (200) is filled with a pressurized gas, such as pressurized xenon. Those of skill in the art will appreciate that while a xenon-type lamp assembly is described herein, other configurations are possible. Such configurations may include, without limitation, an ultra-high pressure mercury-type configuration wherein a burner is coupled to the integrated unit (200). The lamp assembly (410) is located within a housing (430). The housing (430) according to the present exemplary may be relatively small. According to such an exemplary embodiment, it may be desirable to dissipate the energy via convective cooling.

The non-reflective side (440) of the integrated unit (200) is treated to decrease the emissivity. Suitable emissivity decreasing-treatments include, without limitations, polishing or other smoothing operations and/or applying emissivity-decreasing coatings, metallic paints, anodization, and/or multilayered thin film coatings made up of metal-dielectric layers. These treatments cause energy from the reflective side of the burner to be carried away by convection as the surfaces temperature goes up.

This thermal energy is then dissipated through convective cooling. In particular, according to the present exemplary embodiment, a fan (450) directs a cooling airflow (460) to the non-reflective side (440) of the integrated unit. The amount of heat transferred by an object depends, at least in part, on the exposed surface area of the object. The cooling fins (230) may further increase the heat transfer rate by increasing the exposed surface area of the integrated unit (200). The spacing of the cooling fins (230) helps ensure that as air around one cooling fin is heated, that heated air will not substantially heat air around an adjacent cooling fin, thereby slowing heat transfer.

The amount of heat transferred by an object by convection, either natural or forced, depends at least in part on how the air flows over the object. Heat transfer may be maximized by increasing the speed of the airflow and/or by making the airflow turbulent. Accordingly, decreasing the emissivity of the surfaces on the non-reflective side (440) of the integrated unit (200) increases the heat transfer rate of energy dissipated due to convective cooling. The relatively high heat transfer rate from the non-reflective side (440) draws heat away from the reflective surface, thereby maintaining the reflective surface below a predetermined temperature threshold. While a relatively small housing and/or display system has been listed as one possible motive for selecting a convective cooling mode, those of skill in the art will appreciate that any number of motives may make it desirable to select a convective cooling mode.

In some circumstances it may be desirable to select a radiation-primary cooling mode to dissipate heat from a display system (100″). As shown in FIG. 5, one such situation may occur when a lamp assembly (410′) is a relatively large housing (430′). In order to increase the dissipation of energy through radiation, the non-reflective side (440′) of the integrated unit (200) is treated to increase emissivity. According to such an embodiment, the emissivity of the non-reflective side (440′) may be increased by anodization, roughening, weathering, sandblasting, or other such treatments and/or coated with an emissivity-increasing coatings such as non-metallic paints, flat black paints, single or multilayered metal dielectric coatings. As previously discussed, the amount of energy dissipated through radiation depends, at least in part, on the area of the radiating surface. The cooling fins (230) of the integrated unit (200), according to the present exemplary embodiment, may provide increased surface area and thus further increased radiation. The radiation radiated away from the non-reflective side (440′) is directed on the housing (430′). As introduced, the housing (430′) may be relatively large. The relatively large size of the housing (430′) provides increased surface from which the energy directed to the housing (430′) may be dissipated. In particular, according to one exemplary embodiment, the housing (430′) has a radiation absorbing coating applied thereto. The radiation absorbing coating increases the amount of radiation that is absorbed by the housing (430′), which then may be dissipated to the environment surrounding the display system. Maximizing the amount of heat transferred from the non-reflective side (440′) reduces heat build-up in the integrated unit (200), which may increase the useful life of the lamp assembly (410′).

The present apparatuses and methods are related to an integral reflector and heat sink for use in lamp assemblies used in display systems. According to one exemplary embodiment, a reflector is provided that is configured to act as a reflector while providing for enhanced cooling of a lamp assembly. Such as a reflector may be referred to as an integrated unit. The integrated unit includes an emissivity-controlling treatment applied to a non-reflective surface thereof to control the emissivity of that surface. Emissivity refers the relative power of a surface to emit heat by radiation. The emissivity-control treatment may increase the effectiveness of the display system in cooling the lamp. Increasing the effectiveness in cooling the lamp may increase the efficiency of the display system.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the disclosure be defined by the following claims.

What is claimed is:

1. An integral reflector and heat sink for use in a projector assembly, comprising:
a reflector portion comprising an integrated heat sink having a reflective surface and a non-reflective surface opposite said reflective surface; and
an emissivity treatment applied to said non-reflective surface, said emissivity treatment being configured to increase a heat transfer rate through said non-reflective surface.

2. The integral reflector and heat sink of claim 1, wherein said emissivity treatment increases an emissivity of said non-reflective surface.

3. The integral reflector and heat sink of claim 2, wherein said emissivity treatment includes at least one of polishing said surface and applying an emissivity-increasing coating.

4. The integral reflector and heat sink of claim 1, wherein said emissivity treatment includes at least one of roughening, sandblasting, anodizing, weathering, and applying an emissivity-increasing coating.

5. The integral reflector and heat sink of claim 1, wherein said emissivity treatment decreases an emissivity of said non-reflective surface.

6. The integral reflector and heat sink of claim 1, and further comprising a plurality of integral cooling fins connected to said integrated heat sink.

7. The integral reflector and heat sink of claim 1, wherein said reflector portion comprises a metallic material.

8. The integral reflector and heat sink of claim 7, wherein said metallic material comprises at least one of aluminum, zinc, magnesium, brass, and copper.

9. A lamp assembly for use in a projector assembly, comprising:
an integral reflector and heat sink for use in a projector assembly including a reflector portion having an integrated heat sink, said reflector portion having a reflective surface with a reflective coating and a non-reflective surface having an emissivity treatment applied thereto; and
a light generator coupled to said integral reflector and heat sink, said emissivity treatment being configured to increase a heat transfer rate from said non-reflective surface to maintain said reflective surface below a predetermined temperature threshold while said light generator is operating.

10. The lamp assembly of claim 9, wherein said light generator comprises an anode and a cathode sealingly coupled to said integral reflector and heat sink and having pressurized xenon gas within said integral reflector and heat sink.

11. The lamp assembly of claim 9, wherein said light generator comprises an ultra-high pressure mercury burner.

12. A display system, comprising:
a light source module having a reflector with a reflective coating an emissivity treatment applied, said emissivity treatment being configured to maintain said reflective coating below a predetermined temperature threshold while said light source module is operating;
a light modulator assembly in optical communication with said light source module; and
a housing at least partially surrounding said light source module.

13. The system of claim 12, wherein said light source module is configured to preferentially dissipate energy through radiation.

14. The system of claim 13, further comprising a radiation absorbing coating applied to said housing.

15. The system of claim 13, wherein said emissivity treatment increases an emissivity of at least one surface of said reflector.

16. The system of claim 12, wherein said light source module is configured to preferentially dissipate energy through convective cooling.

17. The system of claim 16, wherein said emissivity treatment decreases an emissivity of at least one surface of said reflector.

18. The system of claim 12, wherein said light source module includes a xenon-type lamp assembly.

19. The system of claim 12, wherein said light source module includes an ultra-high pressure mercury burner.

20. A method of forming a lamp assembly, comprising:
providing an integral reflector and heat sink having a reflective surface having a reflective coating applied thereto and a non-reflective surface;
applying an emissivity treatment to said non-reflective surface, said emissivity treatment being configured to increase a heat transfer rate from said non-reflective surface to maintain said reflective surface below a predetermined temperature threshold.

21. The method of claim 20, wherein applying said emissivity treatment includes applying an emissivity decreasing treatment.

22. The method of claim 20, wherein applying said emissivity treatment includes applying an emissivity increasing treatment.

23. The method of claim 20, and further comprising coupling a light generator coupled to said integral reflector and heat sink.

24. A system, comprising:
means for generating light,
means for reflecting said light;
means for modulating said light; and
means for controlling an emissivity of a non-reflective surface to maintain said reflecting means below a predetermined temperature threshold while said means for generating light is generating light.
